(19) United States
(12) Patent Application Publication
(10) Pub. No.: US 2011/0036414 A1
(43) Pub. Date: Feb. 17, 2011

(54) PRESSURE REGULATOR AND BEVERAGE TAPPING APPARATUS PROVIDED THEREWITH

(75) Inventor: Arie-Maarten Paauwe, De Lier (NL)

Correspondence Address: Pearne & Gordon LLP, 1801 East 9th Street, Suite 1200, Cleveland, OH, 44114-3108, US

(73) Assignee: HEINEKEN SUPPLY CHAIN B.V., 1017 ZD Amsterdam (NL)

(21) Appl. No.: 12/935,477

(22) PCT Filed: Mar. 27, 2009
(86) PCT No.: PCT/NL09/50157

§ 371 Date: Nov. 3, 2010

(30) Foreign Application Priority Data
Mar. 31, 2008 (NL) 1035233

(51) Int. Cl. A23L 2/00; B65D 83/00

(52) U.S. Cl. 137/12.5; 222/401

(57) ABSTRACT

A pressure regulator (3) for a tapping apparatus (1), provided with a pressure cartridge (13) and a pressure regulating device (16), wherein the pressure regulating device is coupled to an operating element (5) and comprises at least a first spring element (17) which engages a first side of a movement element (18) of the pressure regulating device (16), while on an opposite side of the pressure regulating device, a space (20) is provided which, during use, is in communication with a compartment of the tapping apparatus, the arrangement being such that when operating the operating element the at least one spring element is tensioned for biasing the pressure regulating device.

The invention relates to a pressure regulator. The invention relates in particular to a pressure regulator for pressure-controlled regulation of pressure in a storage holder such as a beverage holder. The invention furthermore relates to a tapping device provided with such a pressure regulator and a method for regulating pressure in a storage holder such as a beverage holder.

It is known to dispense liquid from storage holders, such as beverage from a beverage container, under the influence of gravity. To that end, gravity flow cans and the like are used. These have as a drawback that the pressure at which the liquid is dispensed is low and not very constant so that in many cases an undesired tapping behaviour develops.

It is further known to dispense liquids such as carbonated beverages with the aid of CO₂ which is supplied via a pressure regulator to a storage holder. Here, a CO₂ bottle can be provided in a tapping apparatus, outside the storage holder, while the pressure regulator is directly connected to the gas bottle and can be connected to the storage holder via a supply line and a handle tapping head. Therefore, these tapping apparatus need a tapping installation that is used over and over, is relatively large and expensive and furthermore requires much maintenance, such as cleaning. Moreover, the pressure regulator needs accurate setting and inspection.

As an alternative, embodiments are known where a gas-containing cartridge is included in the storage holder, together with a pressure regulator, which pressure regulator holds the pressure in the storage holder automatically above a desired lower limit. This pressure regulator is controlled by a pressure difference between a set reference pressure and the actual pressure in the container. Such a pressure regulator is known from, for instance, EP 1 688 814, EP 1 642 861 and NL 1 008 601. Such pressure regulators are mainly used in once-only packages, where tapping takes place almost directly from the storage holder. However, these pressure regulators do not yet provide an optimal pressure regulating behaviour and can thus exhibit a less than ideal tapping behaviour.

In one aspect, the invention contemplates providing a pressure regulator with which a good pressure regulating behaviour can be obtained.

In another aspect, the invention contemplates providing a pressure regulator which is an alternative to the pressure regulators according to the state of the art.

In yet a further aspect, the invention contemplates providing a tapping apparatus with a pressure regulator.

The invention further contemplates providing a method for regulating pressure in a tapping apparatus.

At least one of these and other objects are achieved by the invention.

One aspect of the invention can be characterized by a pressure regulator provided with a pressure cartridge and a pressure regulating device. The pressure regulating device is coupled to an operating element and comprises at least a first spring element which engages a first side of a movement element of the pressure regulating device, while on an opposite side of the pressure regulating device a space is provided which, during use, is in communication with a compartment of the tapping apparatus. Here, all this is designed in a manner such that when operating the operating element, the at least one spring element is tensioned for biasing the pressure regulating device.

Another aspect of the invention can be characterized by a tapping apparatus which is provided with a beverage holder and a pressure regulator, the pressure regulator comprising a pressure cartridge and a pressure regulating device. The pressure regulating device is coupled to an operating element and comprises at least one first spring element which engages a first side of the pressure regulating device while on an opposite side of the pressure regulating device, a space is provided which is in communication with a compartment of the beverage holder. All this is formed such that when operating the operating element the at least one spring element is tensioned for biasing the pressure regulating device.

A further aspect of the invention can be characterized by a method for regulating pressure in a beverage holder, wherein with the aid of a valve body gas supply from a pressure cartridge to the beverage holder is regulated. Here, on a first side of the valve body, a pressure is applied by gas from the pressure cartridge and on a second side of the valve body pressure is applied by a movement element. On the movement element, pressure is applied to one side by the pressure prevailing in the beverage holder and, on an opposite side, by at least one first spring element. The pressure on the side of the spring element is regulated by at least biasing the first spring element with the aid of an operating element. With a pressure in the beverage holder below a desired pressure, the valve body can be brought to an opened position by operating the operating element, and with a pressure in the beverage holder at or above the desired pressure, this opening can not be cleared by operating the operating element.

These and other aspects of a pressure regulator, tapping apparatus and method according to the invention will be further elucidated on the basis of the drawing. In the drawing:

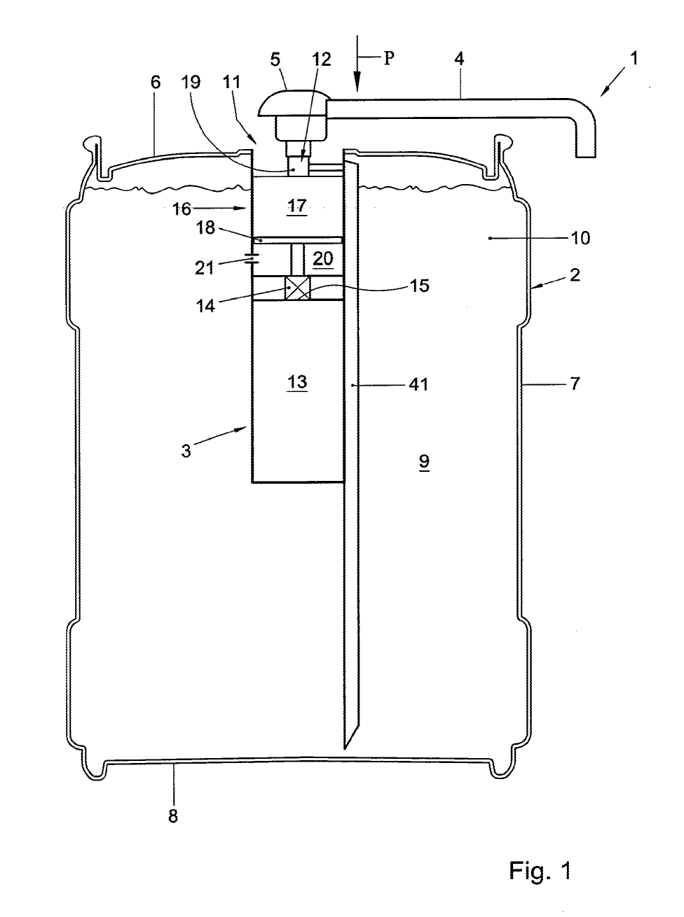

FIG. 1 schematically shows, in partly cross-sectional side view, a tapping apparatus, provided with a beverage holder with a pressure regulator and dispensing tube;

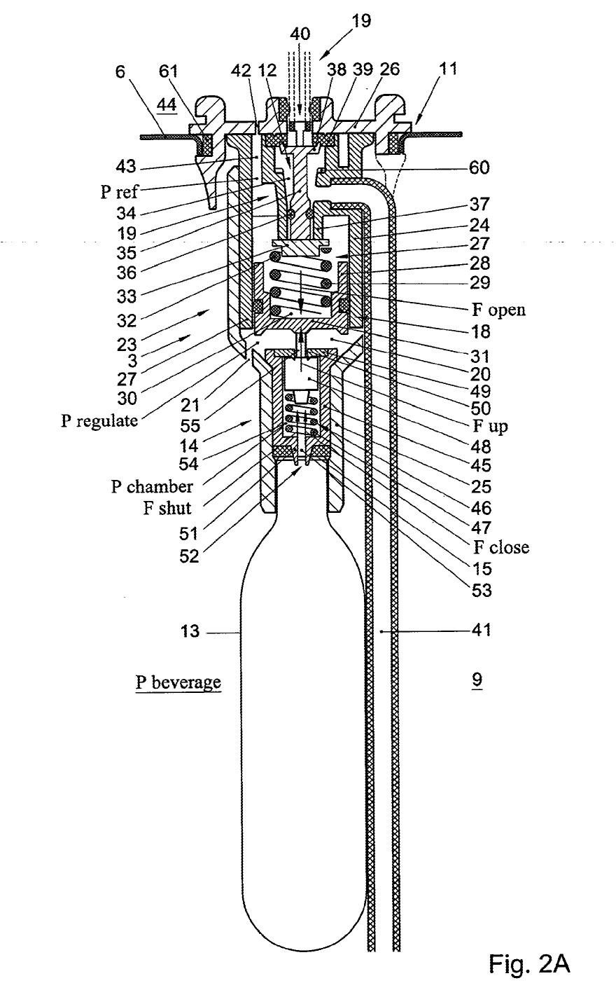

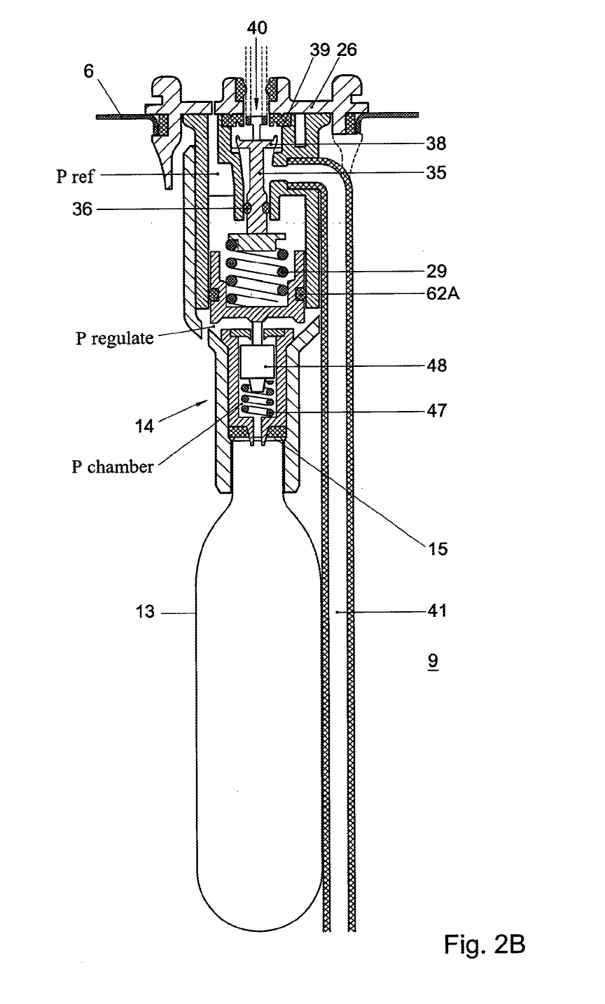

FIGS. 2A and B show, in partly cross-sectional side view, a pressure regulator according to a first embodiment, in two positions;

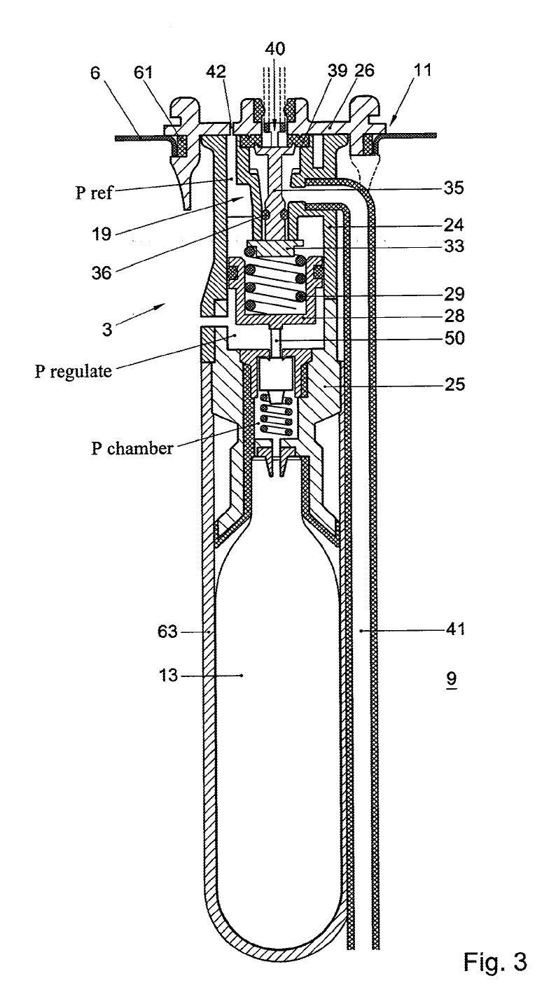

FIG. 3 shows a pressure regulator comparable to the one according to FIG. 2, with a protection around a pressure cartridge;

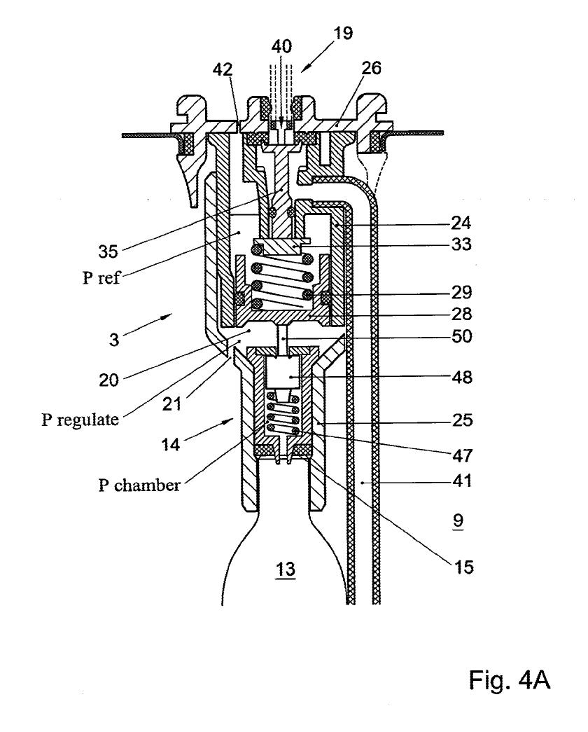

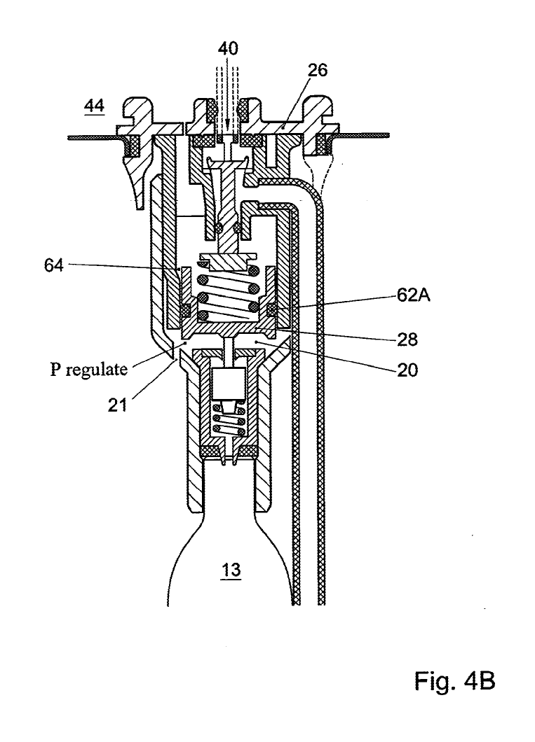

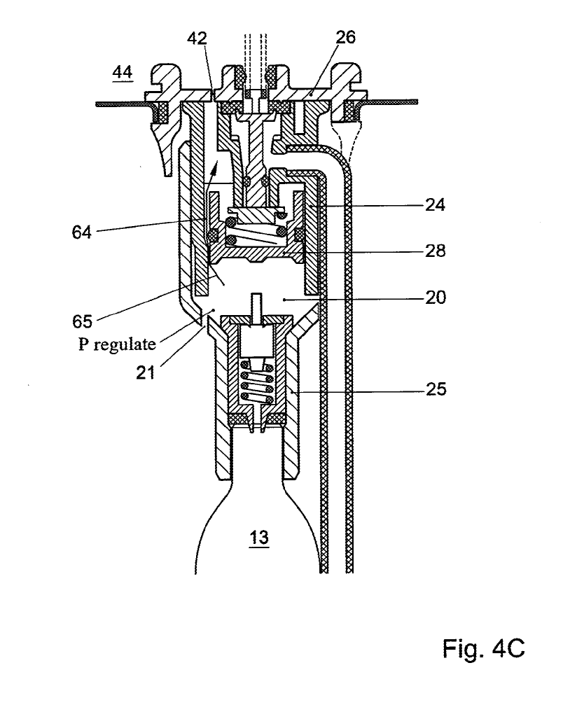

FIGS. 4A-C show, in partly cross-sectional side view, in three positions, a pressure regulator comparable to the embodiment according to FIG. 2, wherein a safety provision is provided;

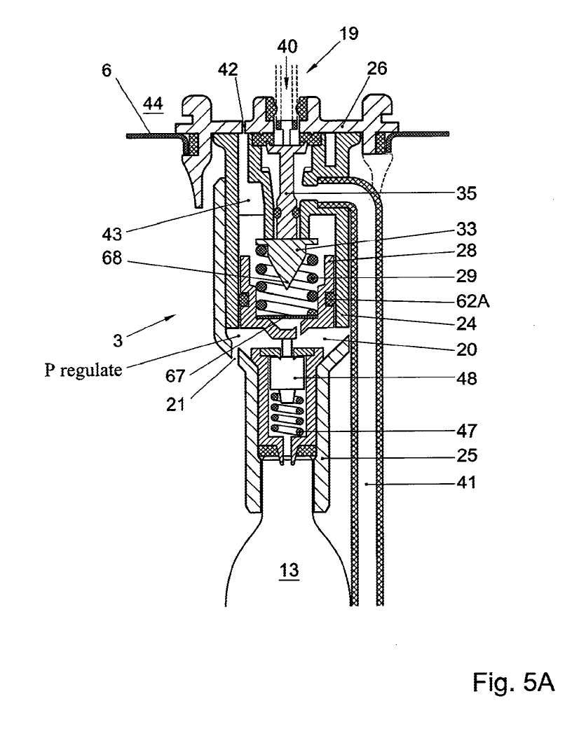

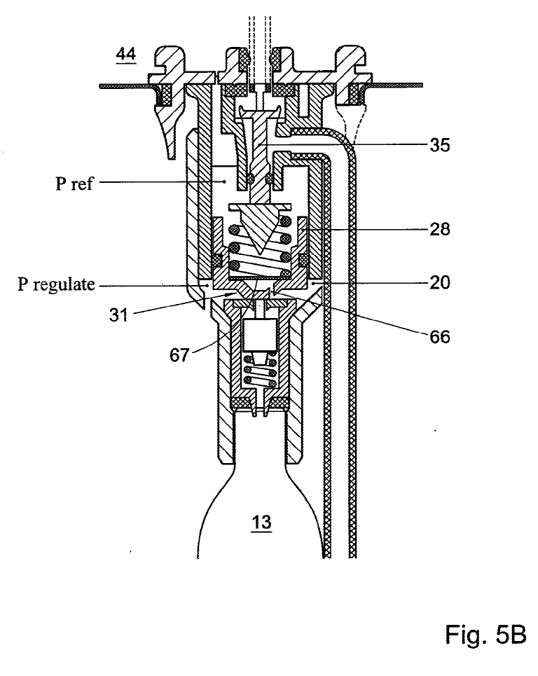

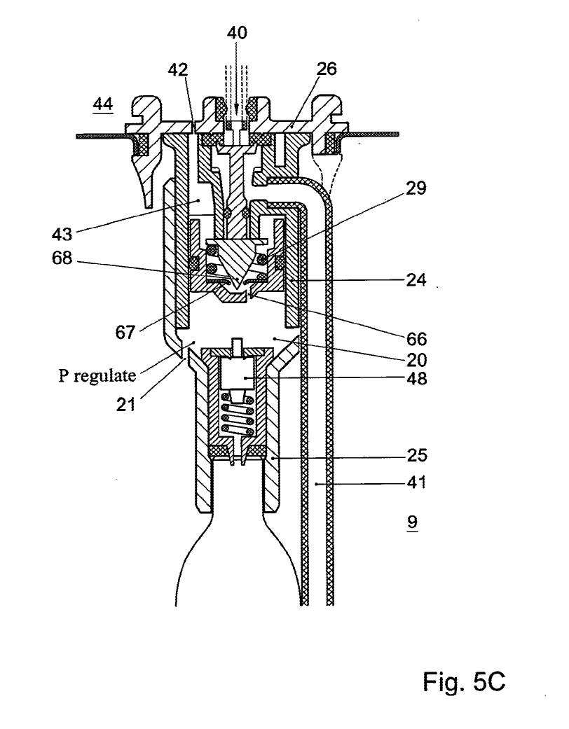

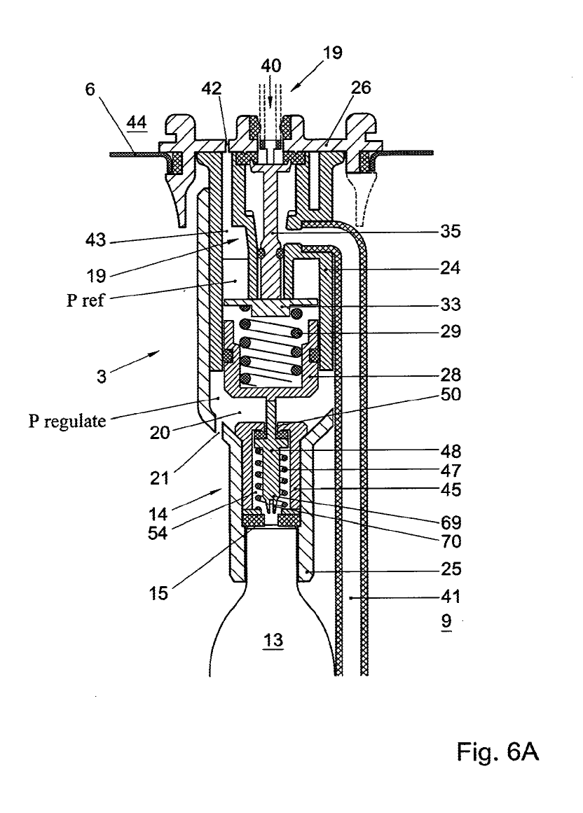

FIGS. 5A-C show, in partly cross-sectional side view, in three positions, a pressure regulator comparable to the embodiment according to FIG. 2, wherein a safety provision is provided;

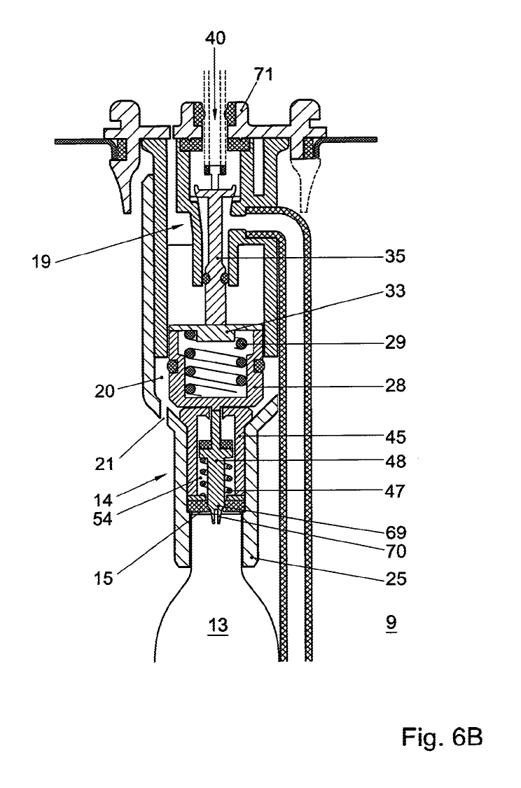

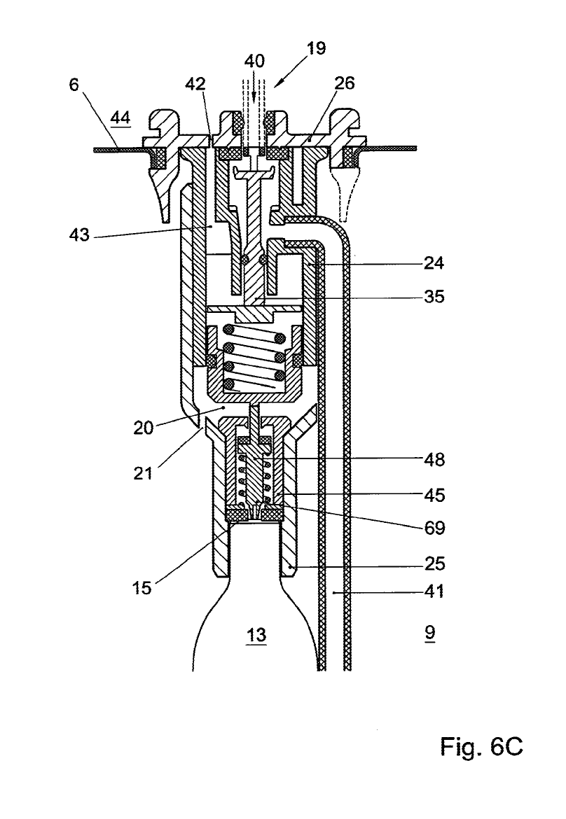

FIGS. 6A-C show, in partly cross-sectional side view, a pressure regulator according to a second embodiment, in three positions;

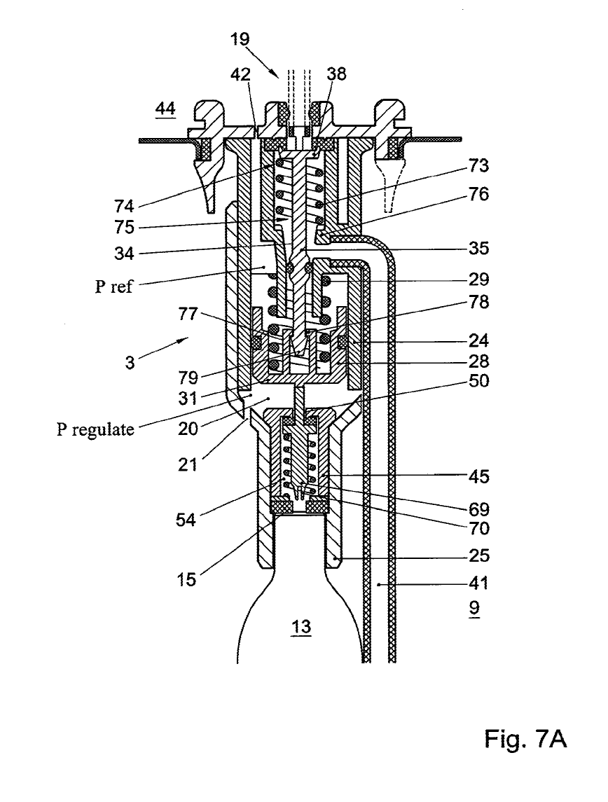

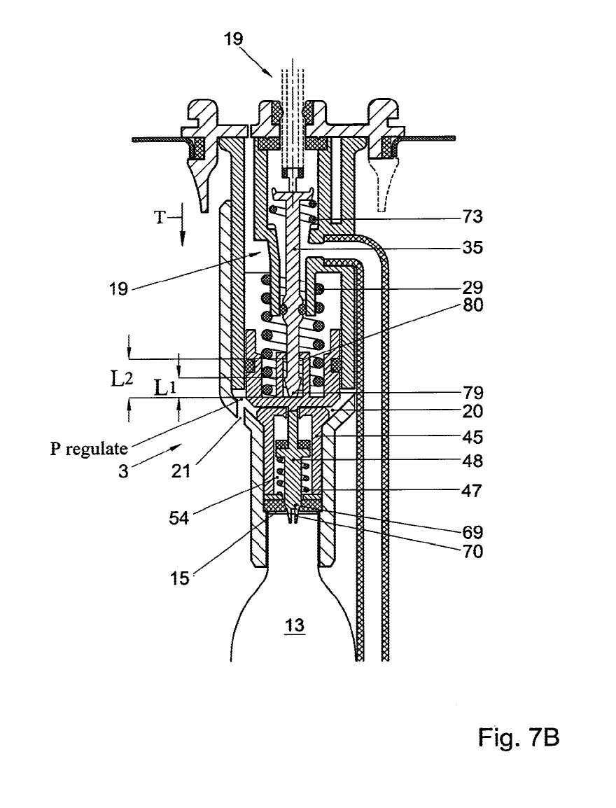

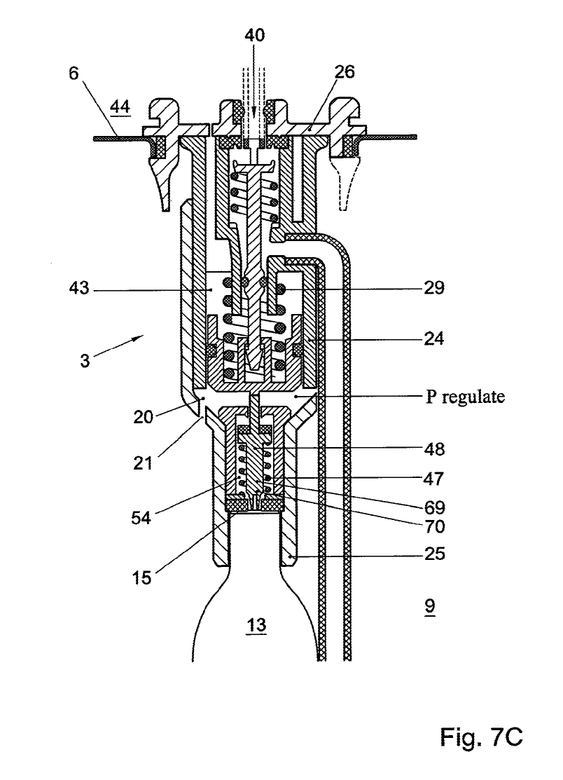

FIGS. 7A-C show, in partly cross-sectional side view, a pressure regulator according to a third embodiment, in three positions;

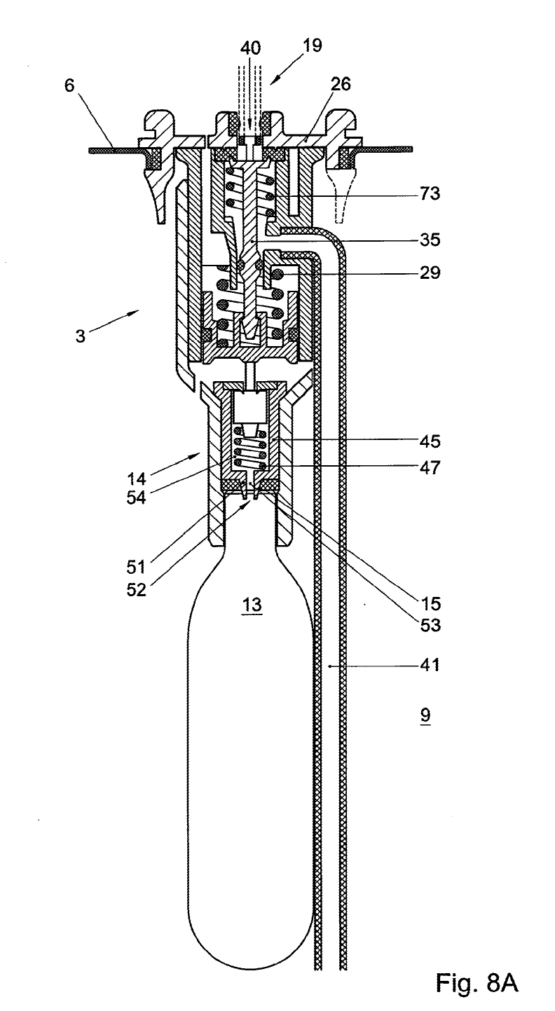

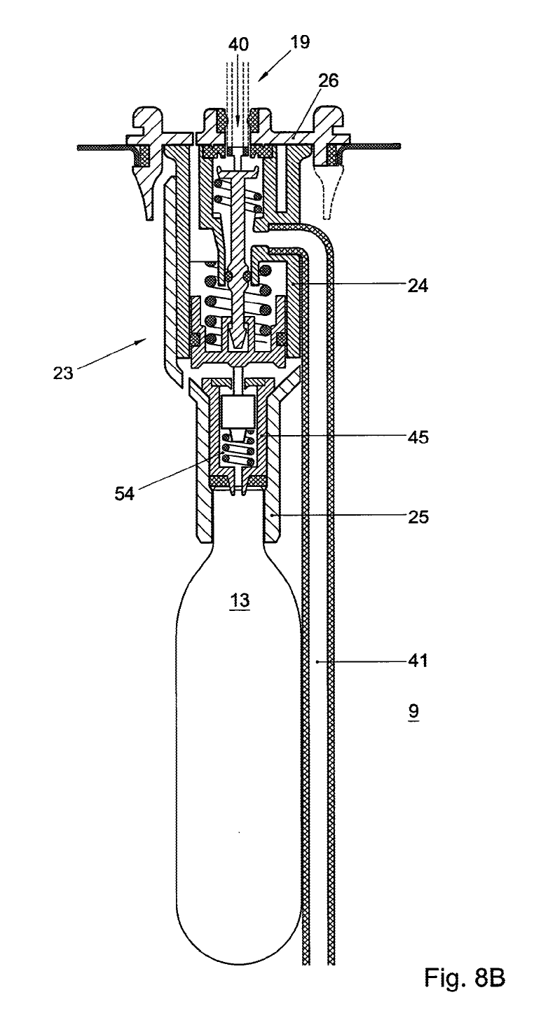

FIGS. 8A-C show, in partly cross-sectional side view, a pressure regulator according to a fourth embodiment, in two positions;

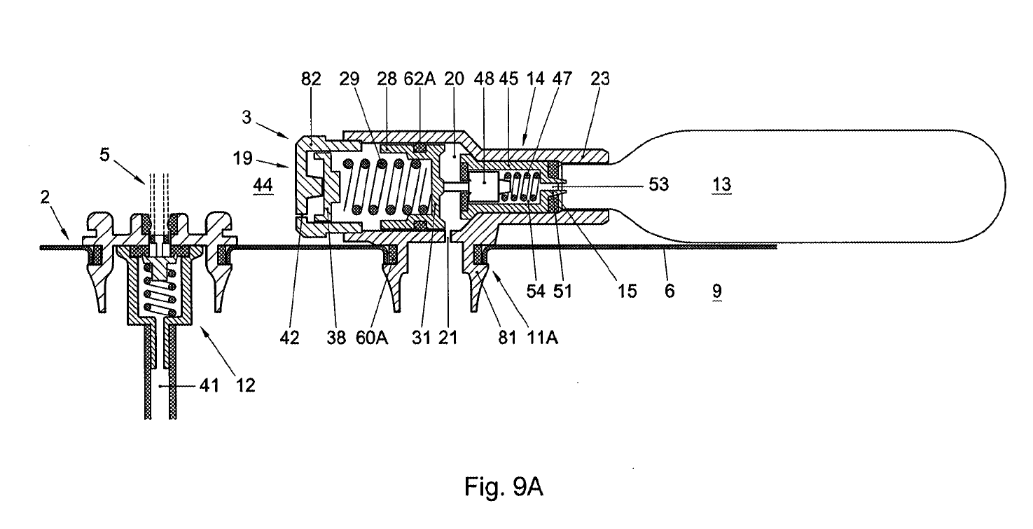

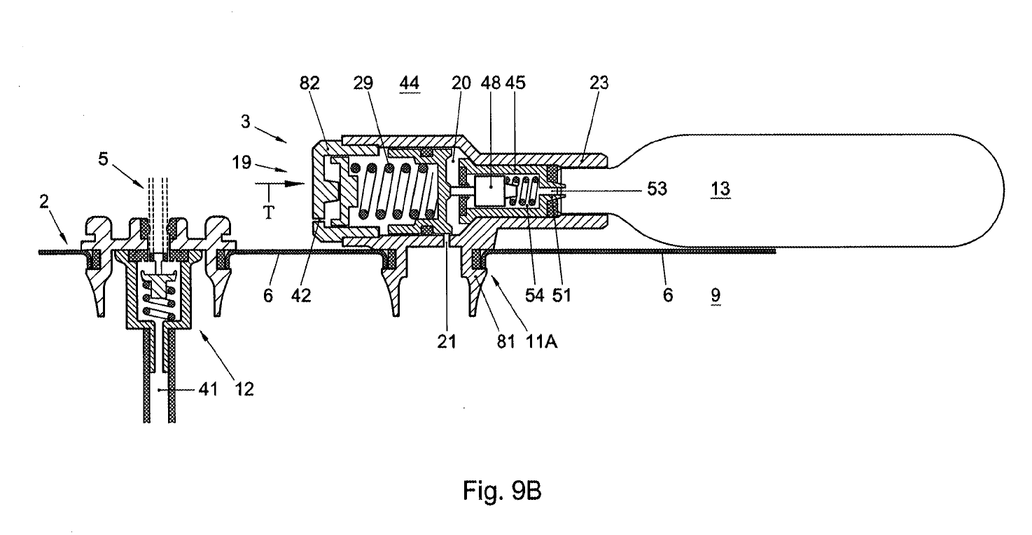

FIGS. 9A-B show, in partly cross-sectional side view, a pressure regulator according to a fifth embodiment, in two positions;

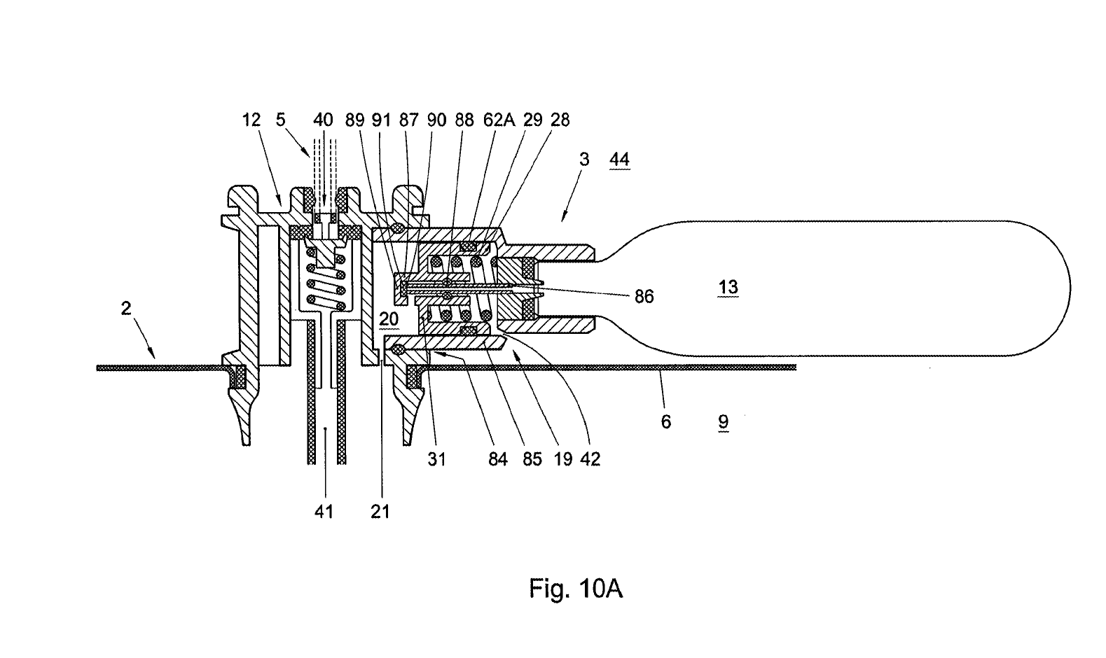

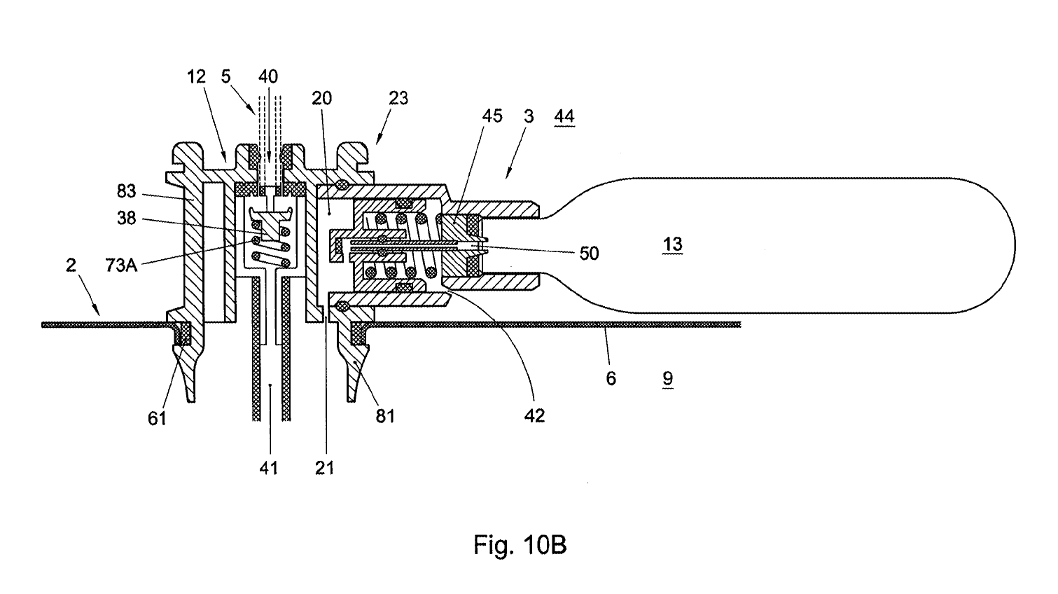

FIGS. 10A-B show, in partly cross-sectional side view, a pressure regulator according to a sixth embodiment, in two positions; and

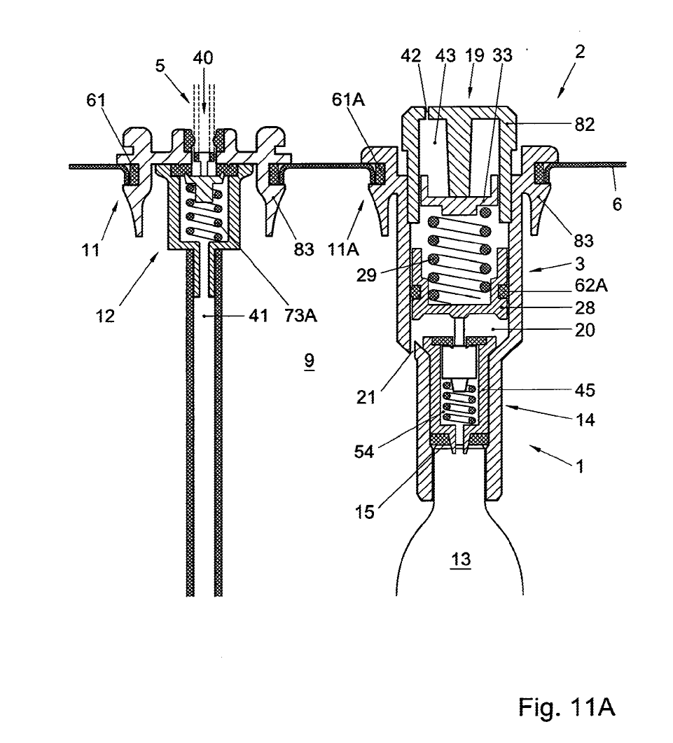

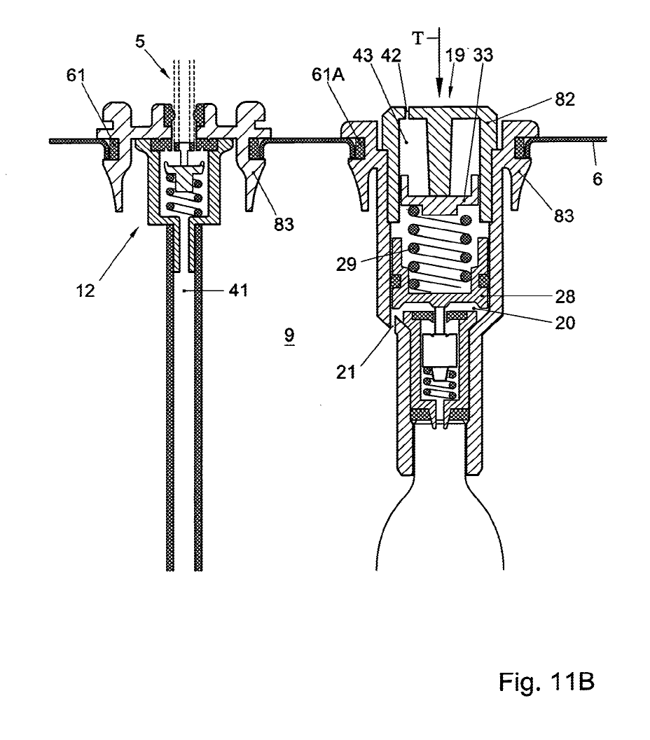

FIGS. 11A-B show, in partly cross-sectional side view, a pressure regulator according to a seventh embodiment, in two positions.

In this description, identical or corresponding parts have identical or corresponding reference numerals. In this description, as exemplary embodiment, elaborations of a tapping apparatus for beverage and pressure regulators suitable thereto will be described. Further, a method will be described on the basis of a method for regulating pressure in a tapping apparatus for beverage. However, these exemplary embodiments should not be taken as being limitative in any manner, neither in the elaboration, nor in use. As beverage, in particular, a carbonated beverage will be described, more particularly beer, but the invention is not limited thereto either.

In one embodiment, a pressure regulator according to this specification can be seen as a pressure regulator with which, in a controlled manner, gas can be brought from a pressure cartridge to an inner space of a storage holder for regulating the pressure therein. Here, the gas can be brought in direct contact with the liquid such as beverage in the storage holder if the gas is allowed to be mixed with the liquid. However, also, a Bag-in-Container (BIC), Bag-in-Box (BIBO) or Bag-in-Bag (BIBA) can be utilized, such that the gas does not contact the liquid. Such storage holders are sufficiently known. In the embodiments shown, always, an embodiment of the first solution is shown. Here, for carbonated beverages, as a gas, it is preferred to use CO₂.

With a pressure regulator according to this description, in embodiments with a pressure regulating device, a valve body between a pressure cartridge and an inner space of the storage holder, such as a beverage container, can be operated between an opened position and a closed position. Here, the pressure regulator can comprise an operating element with which a spring element can be tensioned such that a bias can be set on the valve body in the direction of the opened position. Here, the pressure regulator can be designed such that the operating element is movable between at least two positions. In a first position (position of rest) the bias is relatively low relative to the bias in the second position of the operating element (an operative position). Here, the valve body is biased in the closed position by gas from the pressure cartridge and/or a second spring element. Furthermore, through pressure in a space of the pressure regulator which is in communication with the surrounding of the pressure regulator, such that this space is in communication with or is even formed by an inside of the holder, a force is applied to the pressure regulating device which is opposite to the force that is generated by the bias. The net effect of the different forces in the pressure regulator and in particular in the pressure regulating device is that with the operating element in the first position, during use, the valve body is held in the closed position and that with the operating element in the second position, the position of the valve body is determined by the pressure in the space in the pressure regulator.

With such a pressure regulator, the advantage can be achieved that as long as the operating element is not operated and is therefore in a position of rest, no gas is brought from the pressure cartridge into the inner space of the storage holder, not even when the pressure in the inner space and hence in the space in the pressure regulator drops below a desired pressure. In an advantageous embodiment, the pressure regulator is designed in a manner such that this also holds if the pressure in the space is approximately atmospheric. Thus, the advantage can be achieved that the pressure regulator can be stored in an atmospheric environment, also when the pressure cartridge is opened, without gas escaping from the pressure cartridge via the opening to this environment.

In this description, piercing is understood to include at least, but not exclusively, opening the pressure cartridge by for instance breaking or boring through a sealing such as a seal, cap or the like, or opening by pressing away, unscrewing, pressing open or otherwise opening a valve or such sealing thereof.

In this description, directional indications such as upward, downward, left and right, above, below and next to or comparable terms should be seen as merely an indication with regard to the position and orientation of a respective figure. Other directions of orientation are possible within the invention. In view of the pressure-controlled dispensing, a pressure regulator can be utilized in any desired direction or orientation. In this specification, engaging a side or located on a side of should be understood to mean at least but not exclusively engaging, such as being in contact with or connected to a respective element on or from the side mentioned, or having an effect which occurs from the side mentioned. Here, for instance a point of engagement can be moved relative to an extreme end of the respective element, in the direction of an opposite end, or a particular space or other part can extend partly into a respective element.

FIG. 1 shows, in partly cross sectional view, a tapping apparatus 1, comprising a beverage holder 2 with a pressure regulator 3 therein and a dispensing tube 4 which is connected to an operating button 5. In this embodiment, the tapping apparatus is preferably intended for once-only use, which means that after having been emptied, the tapping apparatus is intended to be completely or partly disposed of or at least not be reused in its entirety. Here, the beverage holder 2 is represented as a container or “can”, manufactured from, for instance, plastic, metal or combinations thereof. The beverage holder 2 is represented in strongly simplified form and is provided with a cover 6, wall 7 and bottom 8. In the drawing, the beverage holder 2 is represented with the cover 6 upward but the beverage holder 2 can have any desired direction of orientation and structure. In he beverage holder 2, an inner space 9 is confined in which beverage 10, for instance a carbonated beverage, such as beer, is provided. However, the invention is also applicable with other types of liquids.

In the beverage holder 2, an opening 11 is provided. In the embodiment shown according to FIG. 1, this opening 11 is provided in the cover 6 but it can also be provided at other positions in the beverage holder 2. The pressure regulator 3 is inserted in the opening 11 and secured therein. Preferably, the pressure regulator 3 seals the opening 11 liquid-tightly and gas-tightly. The operating button 5 with the dispensing tube 4 are provided on an end of the pressure regulator 3 extending outside the inner space 9, on a valve mechanism or tapping valve 12 included therein and to be discussed further, so that through operation of the operating valve the valve mechanism 12 can be opened, whereby beverage 10 can be dispensed from the beverage holder 2 via the dispensing tube 4. A riser 41 can be provided which links up with the tapping valve 12.

In the pressure regulator, a pressure cartridge 13 is provided comprising a fluid under pressure. In one example, this can be CO₂ gas. In a manner to be described further, the pressure cartridge can be brought into fluid communication with the inner space 9 for bringing and/or holding the pressure in the inner space 9 at a desired value.

The pressure cartridge 13 can be a high pressure gas cartridge, filled with liquid CO₂. The internal pressure in the gas cartridge 13 may be higher than 10 bar absolute, more particularly higher than 15 bar absolute. In one embodiment, the internal pressure in the gas cartridge can be higher than 20 bar absolute, for instance 30 bar or more, measured with a gas cartridge completely filled. In one embodiment, this pressure can be approximately 50 bar, at a temperature of approximately 20° C. These pressures are mentioned merely by way of example. In the gas cartridge 13, an amount of CO₂ can be provided such that when virtually the entire beverage holder 2 is filled with CO₂ gas from the gas cartridge, with a pressure in the inner space 9 of the beverage 2 at the desired pressure, still, an amount of CO₂ gas is present in the gas cartridge, preferably an amount of liquid CO₂. For beer or CO₂ containing soft drink, such a desired pressure can for instance be approximately 1.4 to 1.6 bar absolute. The pressure cartridge 13 can also be another gas cartridge, for instance a container with a gas containing substance, a substance absorbing and/or adsorbing gas such as activated carbon, zeolite or other similar materials. Such a container is described in, for instance, NL 1 008 601. Such pressure cartridges are mentioned merely by way of example.

In the pressure regulator 3, further, a device 14 is provided for opening a seal 15 of the pressure cartridge 13 and/or opening a passage between the pressure cartridge 13 and the inner space 9 or at least a space 20 in the pressure regulator. This may be a device for piercing a seal, cap or other sealing 15 of the pressure cartridge or for opening a valve or the like thereof. The pressure regulator 3 further comprises a pressure regulating device 16 in which a first spring element 17 is included. A movement element 18 is provided in the pressure regulating device 16 on which the first spring element 17 engages. An operating element 19 is provided for biasing the first spring element 17. Between the pressure regulating device 16 and the pressure cartridge 13 is provided a space 20 which is in communication, via an opening 21, with the inner space 9. Optionally, in the opening 21, a check valve or such provision can be arranged with which beverage can be prevented from flowing into the space 20 while, conversely, gas can indeed flow via the space 20 and the opening 21 into the inner space 9, and furthermore, pressure equalization between the inner space 9 and the space 20 will be obtained. The operating element 19 can be moved from a first position to a second position. In FIG. 1, by way of illustration, a direction P is indicated for such a movement. With such a movement, the first spring element 17 will be biased against the movement element 18. The tension exerted by the first spring element 17 on the movement element 18 can therefore, with the movement element 18 stationary, be smaller in the first position than in the second position. As a result, the movement element 18 will be pressed away by the first spring element in the second position rather than in the first position.

In FIGS. 2A and B, a first embodiment of a pressure regulator 3 is shown, suspended in the opening 11, with a gasket 61 provided for ensuring the sealing. The pressure regulator 3 comprises a housing 23, in this embodiment substantially built up from a first part 24 and a second part 25. The first part 24 is substantially cylindrical with an at least partly closed top end 26 and an open bottom end 27. In this embodiment, the movement element 18 is a piston which is moveable within the first part 24 and furthermore forms a boundary for the space 20. The piston 28 is substantially hollow at the top. In this embodiment, a first spring element 17 is formed by a compression spring 29 which is inserted from the top into the piston 28 and abuts by an end 30 against a closed end face 31 thereof. On the opposite, second end 32 of the spring 29, a dish 33 is placed. Displacement of the dish 33 towards the end face 31 provides a shortening of the spring 29 and hence an enlargement of the bias on the piston 28 when this is held still. In the first part 24, a cavity 34 is provided above the dish 33, in which a stem 35 of the tapping valve 12 extends. This stem 35 forms the operating element 19 or at least a part thereof. Around a part of the stem 35 adjacent the dish, a gasket 36 is arranged which movably seals against a wall 37 of the cavity 34, On the opposite side of the stem 35, a valve disc 38 is provided which can seal (FIG. 2A) against a gasket 39 provided against the top end 26 of the first part 24, around an outlet opening 40. The riser 41 terminates into the cavity 34, above the gasket 36 and below the valve disc 38. If the stem 35 is moved downwards, in the direction of the piston 28, the valve disc 38 is pressed away from the gasket 39 and beverage can flow from the inner space 9, via the riser 41 and the cavity 34, along the valve disc 38 through the outlet opening 40. It will be clear that during use, the operating button and in particular the dispensing tube 4 will link up with this outlet opening 40. The cavity 34 is formed such that a stop 60 for the valve dish 38 is provided, defining the (extreme) second position.

In the top end 26, a further opening 42 is provided which connects the internal space 43 of the first part 24 around the wall of the cavity 34 and above the piston 28 to the surrounding 44. This allows the pressure P_{ref} in the internal space 43, during use, to be virtually equal to the one in the surrounding 44, and will therefore, as a rule, be atmospheric. This pressure P_{ref} will also be indicated with reference pressure. This means that during use, virtually the only active force Fₒₚₑₙ which is exerted from the top side, i.e. from the side of the operating element 19 on the piston 28, is obtained by the tension of the spring 29.

In this embodiment, the device 14 for opening the seal 15 is arranged in the second part 25 and comprises a bushing 45 which is inserted into the second part 25. In it, a second spring element 46 is provided, designed here as a second compression spring 47. This spring 47 presses a valve body 48 in a closed position, as shown in FIG. 2A, in a sealing manner against a valve seat 49 around an opening 50 which is in communication with the space 20. On the opposite side, the bushing 45 comprises a nose 51 with a sharp point 52 through which a passage 53 extends. In the embodiment shown in FIG. 2, the nose 51 has been pierced through the sealing 15 so that the pressure cartridge 13 is opened (pierced) and gas has flowed from the gas cartridge 13 into the chamber 54 in the bushing 45. As a result, the pressure P_{chamber} in the chamber 54 is substantially equal to the pressure in the gas cartridge 13. Therefore, on the valve body 48, a force Fₛₕᵤₜ acts in the closing direction which force is supplied by the pressure P_{chamber} and the force F_{close} which is exerted thereon by the second spring in the direction of the valve seat. A tappet 55 extends from the valve body 48 through the opening 50 and abuts against the piston 28.

In the space 20, a pressure P_{regulate} will prevail which, prior to use, for instance during storage and transport, will be approximately atmospheric and during use in a beverage holder 2 will be approximately equal to the pressure P_{beverage} in the inner space 9. This will result in a force Fᵤₚ on the piston 28 that is approximately determined by the pressure P_{regulate} times the frontal surface of the piston 28.

In the closed condition shown in FIG. 2A, the force Fₛₕᵤₜ is greater than or equal to the difference between Fₒₚₑₙ and Fᵤₚ. As a result, the valve body 48 is held in the closed position. In the position shown in FIG. 2B, the force Fₛₕᵤₜ is smaller than the difference between F_{open and F}ᵤₚ. This is the result of the compression of the first spring 29 through operation of the operating element 18 (pressing of the stem 35 downwards) and the relatively low pressure P_{regulate} in the space. As a result, the valve body 48 is brought into the opened position. In this condition, gas flows under relatively high pressure through the chamber in the bushing 45 and the opening 50 into the space 20, so that therein, the pressure P_{regulate} is increased. This means that the force Fᵤₚ is increased. When the sum of the force Fᵤₚ and Fₛₕᵤₜ reaches or exceeds the force Fₒₚₑₙ, the valve body 48 will be pressed back into the closed position, irrespective of the position of the operating element 18.

The pressure regulator 3, in particular the springs and the dimensions of the surfaces can be selected such that the pressure P_{regulate} will reach, at most, approximately the equilibrium pressure of CO₂ in the beverage at a desired temperature of use. This may for instance be between 1.6 and 2.0 bar absolute. The P_{regulate} can be selected and/or set depending on for instance the holder 2, the beverage or other preferences. The stop 62 prevents the spring from being compressed further than a preselected length, so that the maximum bias it can provide is limited.

The pressure cartridge can be fastened in any desired manner in the second part or at least in the housing through for instance but not limited to gluing, pressing, pouring in, screw thread, bayonet connection or the like.

FIG. 3 shows a regulating device 3 comparable to the one according to FIG. 2, yet here, the pressure cartridge 13 is included in a closed casing 63, for instance of plastic or metal. The casing 63 links up with the second part 25 of the housing and protects the pressure cartridge 13 against influences from for instance air and the beverage, while furthermore, the beverage is protected from being influenced by the pressure cartridge, for instance oxidation, dispensing of undesired substances, contamination and the like. Another advantageous use of the casing 63 can be that with it, the pressure cartridge can be confined in the housing in a simple manner, while the connection can be gas-tight in an even better and simpler manner. The casing 63 can furthermore simplify assembly, such as guidance during placement in the holder 2, transport and storage can thus be simplified, and air can be prevented in an improved manner from being brought into the holder (trapped air), which air can influence the quality of the beverage. In the casing, a recess can be provided for including and/or guiding the riser. In another embodiment, the riser can be included wholly or partly in such a casing and/or be formed thereby. Such a casing can be utilized with any elaboration of a pressure regulator according to the invention. A pressure regulator 3 can be designed such that it can be inserted through the opening 11 into the beverage holder 2.

FIGS. 4A-C show a part of an alternative embodiment of a pressure regulator 3 comparable to the one according to FIGS. 2 and 3, while an excess pressure protection is provided. Here, the first part 24 of the housing is modified to some extent. In it, in a middle area, a widening 64 is provided. The part 64 located below the widening can sealingly cooperate with the gasket 62A of the piston 28, so that in FIGS. 4A and 4B positions are shown which correspond to those of FIGS. 2A and B, respectively. However, in FIG. 4C, the piston 28 is moved further upwards so that the gasket has entered the widening 64, whereby a direct connection 65 is formed between the space 20 and the opening 42. This situation can arise when, despite the pressure regulator, the pressure in the inner space 9 increases significantly above the desired pressure, for instance due to extreme heating of the beverage holder or leakage. Here, the excess pressure can escape through the connection 65 and be discharged through the opening 42 to the surrounding 44. The gas supply is then closed. When the pressure in the beverage holder 2 and the space 20 has sufficiently dropped, the piston 28 will be pressed back under the widening and use of the tapping apparatus can be resumed.

In FIG. 5, an alternative embodiment of a regulator 3 with excess pressure protection is shown. Here, FIGS. 5A and B substantially correspond to FIGS. 4A and B, respectively, FIG. 5C to FIG. 4C. In this embodiment, the end face 31 of the piston 28 is somewhat hollow and provided with a passage 66. Above the passage 66, within the piston 28 a sealing 67 is provided. This sealing 67 may be a membrane. The dish 33 is provided, on the side proximal to the sealing 67, with a relatively sharp point 68. With normal pressures in the space 20, i.e. approximately equal to or less than the desired pressure P_{regulate}, this point 68 is clearly at a distance from the seal 67. Only when the pressure in the inner space 9 rises to well above the desired pressure P_{regulate}, the piston 28 is pressed upward so far that the point 68 is pierced through the seal 67 and hence connects the space 20 directly to the surrounding 44 for letting off pressure. Contrary to the embodiment according to FIG. 4, this is not reversible.

Naturally, such excess pressure protections can be utilized in all examples shown.

In FIGS. 6A-C, a further regulator 3 is shown in three positions, with the device 14 for opening the pressure cartridge 13 designed differently than in the preceding exemplary embodiments. In the preceding examples, the pressure cartridge 13 is opened when the pressure regulator 3 is assembled, or at least when the pressure cartridge and the bushing are joined. In this embodiment and the one according to FIG. 7A-C, the pressure cartridge 13 can be opened later, for instance by a consumer directly prior to use or in a brewery, for instance after placement of the pressure regulator in a beverage holder. An advantage of such an embodiment is that the relatively high pressure on the valve body is formed only after opening of the pressure cartridge and therefore relatively late in the life cycle of the pressure regulator.

In FIG. 6A, the pressure regulator 3 is shown in a condition prior to use. Here, the structure is substantially comparable to that of pressure regulators as described hereinabove. However, in the chamber 54 in the bushing 45, the valve body 48 is lengthened in the direction of the pressure cartridge 13, with a stem 69 having a relatively sharp end 70. In the position of rest as shown in FIG. 6A, this is at distance from the sealing 15.

In FIG. 6B, a condition is shown in which the stem 35 as operating element 19 is moved maximally downwards. Here, the dish 33 is so wide that it can abut on the top side of the piston 28. As a result, this is activated and moves downwards through direct abutment, for instance until it abuts against the bushing 45. Then, the sharp end 70 is pierced through the seal 15, so that it is pierced and a passage is formed between the pressure cartridge 13 and the chamber 54. In one embodiment, during piercing, a temporary sealing can be obtained between the valve body 48 and seal or sealing 15 or a seal of the pressure cartridge 13. As a result, gas is prevented from flowing away during piercing. Such rapid flowing away could lead to undesired pressure building and formation of ice. When the valve body 48 is moved back upwards, gas under pressure can flow into the chamber 54 and can optionally pass the valve body 48, as far as into the space 20 and the inner space 9. As soon as the sealing 15 has been pierced, the operating element 19 is released and it is pressed back by the spring 29 and optionally the second spring and/or the pressure in the space 20, in the direction of the outlet opening 40. The regulator 3 is thus set for regulating the pressure in the inner space 9 in the before mentioned manner, for instance in a condition as shown in FIG. 6C. Piercing the sealing 15 can take place in the brewery or bottling plant with, for instance, a separate tappet as shown in broken lines in FIG. 6B, which can extend through the opening 40. The tapping apparatus, for instance the operating button, can also be designed such that it can be pressed-in to a relatively large first depth, as shown in FIG. 6B, or to a smaller, second depth, as shown in FIG. 6C. For instance, an operating button (not shown) can be utilized which, prior to piercing, has lips that abut against an outside of the collar 71 around the opening 40, so that the button can make a relatively long stroke and can be pressed-in relatively far, while after the first operation of the operating button, the lips are moved above the collar for instance by elastic or plastic deformation, such that downward movement is limited as the lips run against the top side of the collar. Also, an auxiliary piece can be provided for allowing the piercing movement before a consumer places the tapping means. These examples are merely mentioned by way of example and should not be construed to be limitative in any manner.

In FIGS. 7A-C, a further alternative embodiment is shown, in which also piercing can be obtained after assembly. With this embodiment, the top end of the spring 29 bears against an edge 72 of the first part 24 and extends around a part of the wall of the cavity 34. In the cavity 34, around the stem 35, a third spring 73 is provided which abuts by a first end 74 against de valve dish 38 and by an opposite second end 75 against an edge 76 of the cavity 34. On the end face 31 of the piston 28, a hollow projection 77 is provided which is provided on a side remote from the end face 31 with a restricted opening 78. The stem 35 extends through the opening 78 and is provided at the end inside the projection 77 with a widened head 79. As a result, this end cannot be pulled back through the opening 78. The axial length L₁ of the head 79 is smaller than the axial length L₂ of the inner space 80 of the projection 77. Therefore, the stem 35 can move relative to the piston 28 to some extent, in axial direction T of the stem 35.

In this embodiment, the stem 35 as operating element 19 is moved relatively far downward from the position of rest shown in FIG. 7A to the piercing position as shown in FIG. 7B. Here, the head 79 abuts against the end face 31, so that the valve body 48 can be pressed away maximally and the seal 15 can be pierced. Then, the stem 35 can be released or at least be brought back to a position of use, as shown in for instance, FIG. 7A (the first position or position of rest) or a position as shown in FIG. 7C (a second position or adjustment position) so that, once more, in an above-described manner, pressure can be regulated. Here, neither in the first nor in the second position, the position of the stem directly influences the position of the piston, other than that in the first position, the third spring 73 can pull the stem 35 upwards such that thus, the head 79 holds the projection 77 and hence holds the piston 28 up, also when the pressure in the space 20 is relatively low. Therefore, in this manner, the bias of the spring 29 is influenced. If the stem is moved downwards to some extent, the position of the stem has hardly any influence, if at all, on the extent to which the valve body 48 is pressed away. The position of the stem 35 therefore indeed determines whether or not regulation takes place, but substantially not the level of regulation.

In FIGS. 8A and B, a further embodiment of a regulator 3 is shown, with closed device 14 and opened device 14, respectively, which is substantially equal to the one according to FIG. 7A-C, but where the bushing 45 and the valve body 48 are designed as shown in, for instance, FIG. 2-5. Therefore, in this embodiment, the sealing 15 is once more opened when the pressure cartridge 13 and the bushing 45 are joined.

In FIGS. 9A and B, an embodiment of a regulator 3 is shown which is placed substantially outside the beverage holder 2. Here, the housing 23 is provided, adjacent the opening 21, with a collar 81 with which it can be placed in an opening 11A in the cover 6. A gasket 60A is provided for gas-tight sealing. In this embodiment, the pressure cartridge 13 and the device 14 as well as the piston 28 with spring 29 and tappet are designed as described in, for instance, FIG. 2. Here, the dish 33 abuts against a cap 82 which is slideably received in the housing 23, in an open end thereof. The cap 82 comprises the opening 42 for connection to the surrounding 44. The cap 82 substantially forms the operating element 19. By pushing this cap 82 in the direction T to the pressure cartridge 13, bias of the spring 29 is increased in an above-described manner, so that, depending on the pressure in the space 20, the valve body 48 can optionally be pressed from the seat for introducing gas from the gas cartridge 13 into the inner space 9, as shown in FIG. 9B.

In this embodiment, at a distance from the regulator 3, a dispensing valve or tapping valve 12 is provided, in a manner known per se. A riser 41 can be provided. With such an embodiment, independently of operation of the tapping valve 12, a user can press in the cap 82 in order, if necessary, to adjust the pressure in the beverage holder. An advantage here is that if the pressure in the beverage holder already has a desired height, pressing the button 82 in will have no influence on this pressure. This can also hold for the other embodiments. Further, here, the pressure regulator can be provided after the beverage holder has been filled, for instance through the opening 11A. It will be clear that with such an external pressure regulator, the possibility exists to provide the pressure cartridge 13 only relatively late, for instance directly before use, while placing will lead to piercing.

FIGS. 10A and B show an embodiment of a pressure regulator 3 which is provided with an integrated tapping valve 12 and is arranged on an outside of the beverage holder 2. Here, the housing 23 comprises a first part 83 comprising the tapping valve 12, which first part is secured with a collar 81 in the opening 11, with a fitting gasket. In a side of the first part, a recess 84 is formed in which a second part 85 is fastened. At the location of the recess 84, substantially within the second part 85, the space 20 is formed which is in communication with the inner space 9 of the beverage holder 2 via an opening 21. In the second part 85, on an end opposite the space 20, the pressure cartridge is secured, while there too, the bushing 45 is provided. In the bushing 45, a passage 50 is provided in which a stem 86 is arranged which extends in the direction of the first part 83. The piston 28 is turned with an end face 31 toward the first part 83, so that a hollow side faces the pressure cartridge 13. A spring 29 is included around the stem 86, bearing against an end face 31 and the bushing 45. Through the end face 31, a tube 87 is provided with extends over a part of the length of the stem 86 and is slidingly sealed thereagainst by a gasket 88, for instance an O-ring. An end remote from the pressure cartridge 13 is partly sealed off by a cap 89 in which, as shown in FIG. 10A, an open end 90 of the stem 86 can be fittingly and sealingly included against a gasket 91 if the piston has been pressed maximally towards the pressure cartridge 13, in that the pressure P_{regulate} in the space 20 is higher than or equal to approximately the desired pressure. If this pressure decreases, the piston 28 is pressed in the direction of the first part 83 by the spring 29 and the open end 90 of the stem 86 is cleared so that gas can flow from the pressure cartridge 13 into the inner space 9. The space of the piston 28 is in open communication with the surrounding 44 via opening 42. The pressure cartridge 13 can be coupled to the housing relatively late, for instance by a consumer, thereby opening the sealing 15.

FIGS. 11A and B show, in two positions, parts of a further embodiment of a tapping apparatus 1, wherein a pressure regulator 3 and tapping valve 12 are utilized which are largely comparable to those of FIGS. 9A and B. However, here, the pressure regulator 3 is secured in an opening 11A such that the larger part thereof extends into the inner space 9. In the position shown in FIG. 11A, the pressure regulator is in rest (not activated). Here, it may be so that irrespective of the pressure in the space 20, no gas will be dispensed from the pressure cartridge 13 into the inner space 9. In FIG. 11B, an activated position is shown, wherein pressure changes in the inner space 9 and hence in the space 20 can lead to supply of gas into the inner space 9, as described hereinabove, in that the cap 82 is moved downwards. Here, the cap 82 can be secured in the position shown in FIG. 11B, for instance through clamping or suitably cooperating hooking elements, edges or the like. In another embodiment, the cap 82 can be repeatedly pressed inwards, in that it is pressed upward when the springs are released. Thus, once more, the advantage is achieved that the cap 82 can be operated independently of the tapping valve 12 and that in spite thereof, too high pressures in the inner space are avoided.

When using two openings in the beverage holder, for separate placement of the tapping valve 12 and the pressure regulator 3, at least one of the two can be placed prior to the beverage holder 2 being filled, for instance directly after the manufacture of the beverage holder, which may be logistically advantageous.

The invention is not limited in any manner to the exemplary embodiments given in the drawing and the description. Many variations thereon are possible within the framework of the invention as outlined by the claims.

For instance, as spring means, other elements or constructions can be utilized. For instance, gas springs, leaf springs, elastically deformable elements and the like can be utilized. The movement element can also be formed or comprise a flexible membrane fastened, for instance, in the housing. Housings for a pressure regulator can be assembled from more or fewer parts, can for instance be manufactured completely or partly through 2- or more K-injection molding, or be used with or without riser. A pressure cartridge 13 can be integrated with the beverage holder and can be placed at a distance from the pressure regulator, for instance connected to the pressure regulator 3 by a hose or tube or such channel element. Combinations of parts of the embodiments shown are possible, which are also understood to be included here. Elements of the embodiments shown can be separated, for instance as regards sub-functions or, conversely, be integrated. For instance, the device 15 with, inter alia, the bushing, spring and valve body can be included instead of or near the seal 15 in the pressure cartridge 13 and be included as integral unit, or the dish 33 can be arranged on the stem 35. The tapping means can be of different design than shown. These and many variations are understood to be protected by the claims.

1. A pressure regulator for a tapping apparatus, provided with a pressure cartridge and a pressure regulating device, wherein the pressure regulating device is coupled to an operating element and comprises at least a first spring element which engages a first side of a movement element of the pressure regulating device, while on an opposite side of the pressure regulating device a space is provided which, during use, is in communication with a compartment of the tapping apparatus, the arrangement being such that when operating the operating element the at least one spring element is tensioned for biasing the pressure regulating device.

2. A pressure regulator according to claim 1, wherein a device for opening the pressure cartridge is provided which comprises a valve body that is biased by a second spring element in a closed position against a valve seat, such that the valve body seals off a passage between the pressure cartridge and the said space.

3. A pressure regulator according to claim 2, wherein the pressure regulating device has a tappet which abuts against the valve body, on the side remote from the second spring element, preferably in said space, such that with it, the valve body can be pressed from the valve seat for clearing said passage.

4. A pressure regulator according to claim 1, wherein the first spring element engages the movement element.

5. A pressure regulator according to claim 1, wherein the operating element comprises a dish which engages a first side of the first spring element.

6. A pressure regulator according to claim 1, wherein the pressure regulating device comprises a piston which is located in a housing in a sealingly slideable manner and/or a membrane which is located in a housing so as to be deformable, for forming a movement element, wherein a dish is provided which is connected to or can abut against an operating element and wherein the first spring element comprises a compression spring, included between the dish and the piston and/or the membrane, such that upon displacement of the dish in the direction of the piston and/or the membrane the compression spring is compressed.

7. A pressure regulator according to claim 1, wherein the operating element comprises a tapping valve or forms part thereof.

8. A pressure regulator according to claim 2, wherein the first spring element and the second spring element, the valve body and the movement element are designed such that with atmospheric pressure in the space and the first spring element in the non-biased position, the valve body is held in the closed position by the second spring element and the pressure of gas flowing from the gas cartridge, while with the first spring element in the biased condition the valve body is pressed from the seat when the pressure in the space is lower than a preselected desired pressure.

9. A pressure regulator according to claim 1, wherein a stop is provided for limiting the freedom of movement of the operating element.

10. A pressure regulator according to claim 1, wherein the operating element comprises at least a part of a tapping valve.

11. A tapping apparatus, provided with a beverage holder and a pressure regulator, wherein the pressure regulator comprises a pressure cartridge and a pressure regulating device, wherein the pressure regulating device is coupled to an operating element and comprises at least a first spring element which engages a first side of the pressure regulating device, while on an opposite side of the pressure regulating device a space is provided which is in communication with a compartment of the beverage holder, the arrangement being such that when operating the operating element the at least one spring element is tensioned for biasing the pressure regulating device.

12. A tapping apparatus according to claim 11, wherein the pressure regulator comprises a housing, wherein the pressure regulating device comprises a piston and/or a membrane, sealingly movable within the housing, which piston and/or membrane bounds said space at least partly.

13. A tapping apparatus according to claim 12, wherein the first spring element engages the side of the piston and/or the membrane remote from said space and the operating element engages the side of the first spring element remote from the piston and/or the membrane.

14. A tapping apparatus according to claim 12, wherein on a side of said space remote from the piston and/or the membrane a seal of said space is provided in which an opening is provided for connecting said space to the pressure cartridge, wherein adjacent the opening a valve seat is provided against which a valve body can seal, which valve body is biased by a second spring element in the direction of the valve seat.

15. A tapping apparatus according to claim 14, wherein through the opening a tappet extends for pressing the valve body away from the valve seat with the aid of the piston and/or the membrane.

16. A tapping apparatus according to claim 1, wherein in the said space a first pressure prevails, on the side of the piston and/or the membrane remote from said space a second pressure and on the side of the valve body remote from said space a third pressure, wherein:
if a first sum of the force exerted as a result of the first pressure exerted on the piston and/or the membrane and the force exerted by the tappet on the piston and/or the membrane is greater than a second sum of the force exerted by the second pressure on the piston and/or the membrane and the force exerted by the first spring element on the piston, the valve body abuts sealingly against the valve seat, irrespective of the position of the operating element; and
if the first sum is smaller than the second sum, the valve body is moved away from the valve seat;
wherein, during use, the first pressure can be higher than the second pressure and the first spring element, with the operating element in a first position, exerts a smaller force on the piston and/or the membrane than in a second position of the operating element, such that the first sum can only be smaller than the second sum if the operating element has been moved away from the first position to or in the direction of the second position.

17. A tapping apparatus according to claim 11, wherein the operating element comprises at least a part of a tapping valve.

18. A tapping apparatus according to claim 11, wherein a riser is connected to the pressure regulating device, in particular adjacent the operating element, and extends to near a bottom of the beverage holder.

19. A method for regulating pressure in a beverage holder, wherein with the aid of a valve body gas supply from a pressure cartridge to the beverage holder is regulated, wherein on a first side of the valve body a pressure is exerted by gas from the pressure cartridge and on a second side of the valve body pressure is exerted by a movement element, wherein on the movement element on one side pressure is exerted by the pressure prevailing in the beverage holder and on an opposite side by at least a first spring element, wherein the pressure on the side of the spring element is regulated by at least biasing the first spring element with the aid of an operating element, wherein with a pressure in the beverage holder below a desired pressure, the valve body can be brought to an opened condition through operation of the operating element and, with a pressure in the beverage holder at or above the desired pressure, said opening cannot be cleared through operation of the operating element.
